(19) United States
(12) Patent Application Publication
(10) Pub. No.: US 2006/0006128 A1
(43) Pub. Date: Jan. 12, 2006

(54) Cap capable to be screwed in with nipple and cover cap

(76) Inventor: Maria Genoveva Del Carmen Resendiz Sanudo, Zapopan (MX)

Correspondence Address: Orum & Roth LLC, 53 West Jackson Blvd., Chicago, IL, 60604, US

(21) Appl. No.: 11/158,177

(22) Filed: Jun. 21, 2005

(30) Foreign Application Priority Data
Jun. 22, 2004 (MX) JL/A/2004/000016

(51) Int. Cl. A61J 9/08

(52) U.S. Cl. 215/11.6

(57) ABSTRACT

This invention refers to a cap capable to be screwed in with nipple and cover cap which allows that refreshment or water bottles which have a conventional screw thread system can be used as baby's bottles. Its characteristics are: a cap (observe FIGS. 1. 2 and 3) which it joins to, by means of a continuous thread system (3), in its inferior part, a bottle with ring neck; its superior mouth has a surrounding extension which stands out the raised edge (1), this mouth has a central perforation (2) which allows passing a nipple through (see FIGS. 1, 2 and 4); it also has surrounding lug in its internal superior part which is used as a tie (4) this makes the adjustment to the inferior extreme (7) of the nipple when it passes in, the bottle and nipple are joint together by the cap capable to be screwed in. In like manner a cover cap has been adapted (see FIGS. 2 and 5) with a reduced diameter in its inferior part (8) which is equal to the size of the superior part of the cap capable to be screwed in with a internal prominence which allows this one to fit by pressure (9) in the cap capable to be screwed in covering the nipple.

### BACKGROUND OF THE INVENTION

1. Field of the Invention

The present invention relates to baby bottles. More specifically it relates caps with nipples for use with water of drink bottles.

2. Description of Related Art

At present time caps with a nipple existing in the market consist of a spiral-shaped inside, with a superior central perforation which allows to place in a nipple which joins with the open superior side of a baby's bottle by means of a screw thread system. Such caps are designed basically to be screwed in to a baby's bottleneck or container; these caps cannot be used in the entrance mouth of a refreshment or conventional water bottle which has a cap with a screw thread system. This situation forces the user to pour the water or the refreshment contained in such bottle into the baby's bottle which has to be washed and desinfected previously. See NSOL U0249068 presented by distribuidora Elmu, S.A. as well as the following internet pages www.luvcare.com.mx/catalogo.htm(biberones),www.gerber.com.mx/htm/accesorios/biberones.htm, www.evenflo.com.mx, (see products-baby's bottles-accesories-4 threads-).

In like manner, caps capable to be screwed in have been manufactured. They comprise of: a piece which takes the place of a unitary little screw thread of a water or conventional refreshment bottle but with an increase in their size in a significant way so they can receive in their interior the ring neck of a bottle. They consist also of a cap with a superior orifice where the nipple passes in and its interior side has screw threads which are located in a circumference form so it allows the joining of the cap with the piece which takes the place of the screw thread of the bottle. (To be screwed in). They also consist of a nipple which is introduced into the cap capable to be screwed in, in order to join together through the piece which simulates the neck of a bottle. And a cap which covers the nipple. As it can be thought, this big number of elements makes it difficult to use the product and raises the cost of it. See eg. patent Infant Nipple adapter for a bottle comprising a screw ring with Pat. No. 5,024,341 and Nipple adapter with patent number U.S. Pat. No. 6,354,449 B1.

### SUMMARY OF THE INVENTION

In order to suppress this impediments, a cap capable to be screwed in with a nipple and cover cap were developed. The inventive cap consists of a single product, comprised of only three elements which are capable to be screwed in to the neck of any kind of water or refreshment bottle which has a screw thread system, which allows the baby to drink their contents as they were baby's bottles, eliminating with this the need to sterilize and to wash the bottles as well as the need to pour the water or refreshment contained in them into the baby's bottle.

This invention refers to a cap capable to be screwed in with nipple and cover cap which allows that refreshment or water bottles which have a conventional screw thread system can be used as baby's bottles. Its characteristics are: a cap (observe FIGS. 1. 2 and 3) which it joins to, by means of a continuous thread system (3), in its inferior part, a bottle with Ring neck; its superior mouth has a surrounding extension which stands out the raised edge (1), this mouth has a central perforation (2) which allows passing a nipple through (see FIGS. 1, 2 and 4); it also has surrounding lug in its internal superior part which is used as a tie (4) this makes the adjustment to the inferior extreme (7) of the nipple when it passes in, the bottle and nipple are joint together by the cap capable to be screwed in. In like manner a cover cap has been adapted (see FIGS. 2 and 5) with a reduced diameter in its inferior part (8) which is equal to the size of the superior part of the cap capable to be screwed in with a internal prominence which allows this one to fit by pressure (9) in the cap capable to be screwed in covering the nipple.

The characteristic details of this new cap cabable top be screwed in with nipple and cover cap are shown clearly in the following description and in the drawings attached hereto, following the same reference signs in order to indicate the parts and the figures shown.

### BRIEF DESCRIPTION OF THE FIGURES

FIG. 1 is a general perspective of the cap capable to be screwed in, the nipple and the cover cap as a whole which conforms the invention. FIG. 2 is sight of a longitudinal sight of the cap capable to be screwed in with nipple and cover cap already integrated.

FIGS. 3, 4 and 5 are longitudinal sights of the cap capable to be screwed in which can be adapted to any kind of bottle, whether it is a refreshment or water bottle, a longitudinal sight of the nipple to be inserted in the cap capable to be screwed in and another one of the cover cap which is used to cover the nipple, respectively.

### DETAILED DESCRIPTION OF THE INVENTION

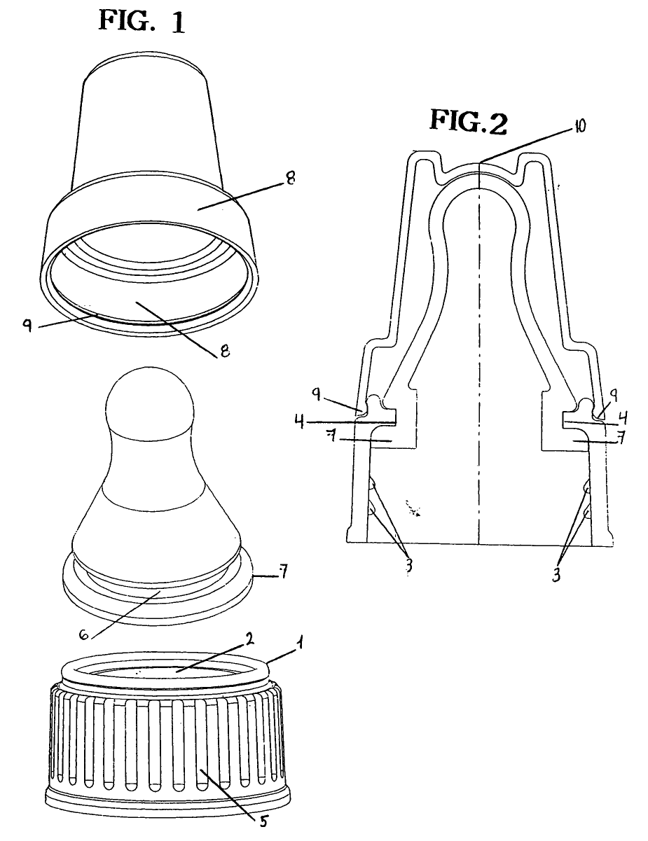

Referring to FIGS. 1, 2 and 3, the cap capable to be screwed in with nipple and cover cap is formed by a cap with a thread, made of rigid plastic in varied colors. The constitution of such cap capable to be screwed in is seen in FIGS. 1,2 and 3 where it can be observed that in the superior part of the same, it has been made suitable a peripheric prolongation 1 which stands out through the border and which has a hole 2 necessary to introduce a nipple (FIG. 4). In like manner it has the peculiarity to bear a threaded segment 3, which is located in the interior wall and it helps so this item can be joint to the neck of any kind of refreshment bottle or water which has a thread system, it has also a surrounding protuberance 4 which is located in the superior section of the cap which is used as a stop when the nipple is introduced through the inferior of the cap, being secured firmly.

The design to the cap (which is only seen in FIGS. 1, 2 and 3) constitutes, in part, the novelty of it, as the diameter and the height of the raised edge 1 which is located in its superior part helps the nipple (FIG. 4.) to be introduced and fits in the same, in like manner it has grooves or channels (FIG. 1, no.5) in the exterior part of its circumference of the threaded cap which allow the bottle to be opened and closed easily.

Some of the new elements of this product which complements its operating conditions, are the nipple (observe FIGS. 1,2 and 4) which is the same as a conventional one with the difference that in its inferior part 6 it has a reduced diameter to the size of the mouth of the bottles with a standard cap capable to be screwed in, and it has a peripheric edge 7 designed to be inserted against the lug or lateral tie 4 which is located in the interior wall of the cap capable to be screwed in, at the moment to be introduced to the same, so such tie 4 captures a portion of the nipple physically 7 in order to guarantee a secure interconexion between the tie 4 and the nipple. The nipple can be manufactured of different materials as long as they are soft and easy to wash, among them latex or silicone.

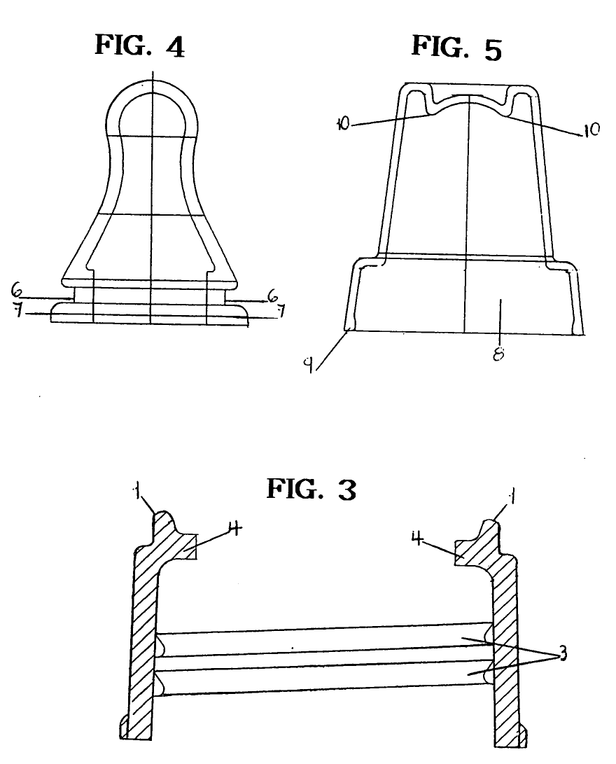

As an auxiliary accessory, there's the removable cap (which is seen in FIGS. 1,2 and 5) a little bit narrower in its inferior part than a conventional cap (8) which is adjusted by pressing it to the superior part (1) of the piece which constitutes the cap capable to be screwed in with-nipple (FIG. 3), this is reached through the coupling of the interior surrounding protuberance located in the interior part of the cap (9) to the neck of the cap capable to be screwed in (1); it has as well a fitting in its internal superior part (10) which has a convex form needed to place the nipple in order to avoid that the nipple has contact with polluting agents as well the spilling of the liquid contained in the bottle; the cap can be manufactured of transparent or color.

In this way, one can get a cap capable to be screwed in with a nipple which characteristics are:
a) Its practicability, as it allows purified water bottles which have an open-close mechanism by means of a standard screw thread cap to be used as they were baby's bottles ready to use only by screwing in the cap with the nipple to the neck of the bottle.
b) Its economy, as it avoids the unnecessary buying of baby's bottles.
c) Its easiness to be manufactured
d) saving of time and work, as it avoids the sterilization of baby's bottles as well as the washing of them for a subsequent use:

For all what has been aforementioned, it can be affirmed that the characteristics of the cap capable to be screwed in with a nipple have not been achieved by any other similar device yet and it meets the qualities to be a practical and useful device.

I claim:

1. Cap capable to be screwed in with nipple and cover cap comprising a cap with thread made of 100% high density polyethylene which adjusts to the superior mouth of a water or refreshment bottle which has a standard thread cap system, a continuous little thread in the internal inferior part which joins to the threaded exterior neck of a bottle and a extreme pass central perforation for a nipple.

2. Cap capable to be screwed in with nipple and cover cap according to claim 1 further comprising in an cylindric exterior surface of the cap grooves or slots which continue in an exterior ring-shaped zone of the cap and also have a surface of complementary hollow fastening with the forming of convex fastening which ease the opening and closing of the cap.

3. Cap capable to be screwed in with nipple and cover cap according to claim 1 further comprising in the external superior part of the cap capable to be screwed in, a peripheric extension of a smaller size than the circumference of the cap which stands out of the edge of the cap
a central orifice which is used as a threaded mouth to receive a nipple,
and an interior peripheric tie in the superior part of the cap which is used as a stop so it fits the flange which surrounds a inferior part of the nipple.

4. Cap capable to be screwed in with nipple and cover cap according to claim 3 wherein the nipple is manufactured of zahoprene 100; latex 100%, Silicone 100% or thermo plastic rubber, and wherein the nipple presents a perimetric reduction in its inferior part as well as a peripheric salient in the base which is used so it hooks in the internal superior part of cap.

5. Cap capable to be screwed in with nipple and cover cap according to claim 1 wherein the cap is 100% crystal polystyrene, transparent or in colors, and wherein the inferior diameter of that cap is reduced, to allow the surrounding raised edge which is located in the internal inferior part of the cap, to adjust tightly over a lug of the superior part of the cap capable to be screwed in and; an internal tubular shape able to lodge the nipple inside, to isolate the nipple from the surrounding environment.

6. Cap capable to be screwed in with nipple and cover cap according to claim 2 wherein the cap is 100% crystal polystyrene, transparent or in colors, and wherein the inferior diameter of that cap is reduced, to allow the surrounding raised edge which is located in the internal inferior part of the, to adjust tightly over a lug of the superior part of the cap capable to be screwed in and; an internal tubular shape able to lodge the nipple inside, to isolate the nipple from the surrounding environment.

7. Cap capable to be screwed in with nipple and cover cap according to claim 3 wherein the cap is 100% crystal polystyrene, transparent or in colors, and wherein the inferior diameter of that cap is reduced, to allow the surrounding raised edge which is located in the internal inferior part of the, to adjust tightly over a lug of the superior part of the cap capable to be screwed in and; an internal tubular shape able to lodge the nipple inside, to isolate the nipple from the surrounding environment.

8. Cap capable to be screwed in with nipple and cover cap according to claim 4 wherein the cap is 100% crystal polystyrene, transparent or in colors, and wherein the inferior diameter of that cap is reduced, to allow the surrounding raised edge which is located in the internal inferior part of the, to adjust tightly over a lug of the superior part of the cap capable to be screwed in and; an internal tubular shape able to lodge the nipple inside, to isolate the nipple from the surrounding environment.

9. Cap capable to be screwed in with nipple and cover cap according to claim 2 wherein the nipple is manufactured of zahoprene 100; latex 100%, Silicone 100% or thermo plastic rubber, and wherein the nipple presents a perimetric reduction in its inferior part as well as a peripheric salient in the base which is used so it hooks in the internal superior part of cap.

10. Cap capable to be screwed in with nipple and cover cap according to claim 3 wherein the nipple is manufactured of zahoprene 100; latex 100%, Silicone 100% or thermo plastic rubber, and wherein the nipple presents a perimetric reduction in its inferior part as well as a peripheric salient in the base which is used so it hooks in the internal superior part of cap.
